(19) United States
(12) Patent Application Publication
(10) Pub. No.: US 2010/0146840 A1
(43) Pub. Date: Jun. 17, 2010

(54) Plug-in device for attracting and exterminating pests

(76) Inventor: Steven L. Troutman, Virginia Beach, VA (US)

Correspondence Address: LEIGH P. GREGORY, PO BOX 168, CLEMSON, SC, 29633-0168, US

(21) Appl. No.: 12/653,450

(22) Filed: Dec. 14, 2009

Related U.S. Application Data
(60) Provisional application No. 61/201,593, filed on Dec. 13, 2008.

(51) Int. Cl. A01M 1/20

(52) U.S. Cl. 43/144

(57) ABSTRACT

A plug-in device for controlling and exterminating pests includes an electrically powered heat source, a source of a volatile material adjacent to the heat source, the volatile material including at least a pesticide, and a source of carbon dioxide, wherein emitted heat and carbon dioxide attract the pests and wherein the volatile material is vaporized by the heat, thereby exterminating the attracted pests.

The present application claims the benefit of prior provisional application U.S. Ser. No. 61/201,593, filed Dec. 13, 2008.

### FIELD OF THE INVENTION

The present invention is directed to a plug-in device for attracting and exterminating a variety of pests, specifically bed bugs.

### BACKGROUND OF THE INVENTION

Bed bugs are increasingly becoming a problem within residences of all kinds, including homes, apartments, hotels, cruise ships, dormitories and shelters. Small wingless insects that feed solely upon the blood of warm-blooded animals, bed bugs and their relatives have evolved as nest parasites. Certain kinds inhabit bird nests and bat roosts and await the return of their hosts; others have adapted well to living in the ‘nests’ (homes) of people.

Bed bugs and their relatives occur nearly worldwide. They became relatively scarce during the latter part of the 20^{th} century, but their populations have resurged in recent years, particularly throughout parts of North America, Europe, and Australia. They are most abundant in rooms where people sleep, and they generally hide nearest the bed or other furniture used for sleeping. Bed bugs are most active in the middle of the night, but when hungry, they will venture out during the day to seek a host. Their flattened bodies allow them to conceal themselves in cracks and crevices around the room and within furniture. Favored hiding sites include the bed frame, mattress and box spring. Clutter around the room offers additional sites for these bugs to hide, and increases the difficulty in eliminating bed bugs once they have become established. While an annoyance for individuals in private residences, the recent increase in the bed bug population represents a serious concern for the hotel and cruise ship industries.

Currently, efforts to control this problem have included replacing carpet with solid surface floorings such as tile, favoring a minimalistic design free of excess drapes, upholstery and other textiles, encasing mattresses in impervious textiles or films, and spraying freshly applied sheets with an insecticide known to kill bed bugs or control their population. However, the problem continues and further efforts are needed.

Copending application U.S. Ser. No. 12/590,961, is directed to a laundry additive containing an insecticidally effective amount of an insecticide for treating linens and other textiles used on or near a sleeping surface. Such laundry additives are appropriate for use by institutions such as hotels, cruise ships, and nursing homes, hospitals, and shelters in the prevention and control of bed bugs.

Plug-in devices for deodorizing and adding fragrance to a room are well known in the art. Typically such devices plug into an electrical outlet and rely upon a small degree of electrical heating to dispense fragrance. Exemplary air fresheners that plug into electrical outlets are commercially available under the names GLADE® PLUGINS, AIR WICK®, and RENUZIT® SCENTED OIL AIRLETS. Exemplary patent documents disclosing plug-in air fresheners include U.S. Pat. No. 5,937,140 to Leonard et al., U.S. Pat. No. 6,044,202 to Jankel, U.S. Pat. No. 4,837,421 to Luthy, and U.S. Pat. No. 6,968,124 to Varanasi, et al., all of which are hereby incorporated herein by reference. Among others, the Luthy and Varanasi, et al. patents suggests including volatile substances such as pesticides with the fragrance. However, these prior art patents do not suggest providing a means for attracting the pests to the pesticide.

Plug-in devices, typically for outdoor use, are known which attract and kill flying pests. Devices known as “bug zappers” attract pests with a fluorescent light and kill those pests with a high-voltage electric current. More recent devices employ heat and carbon dioxide as a means to attract flying pests. The pests are then trapped or killed by electrocution. An exemplary device is disclosed in U.S. Pat. No. 6,305,122 to Iwao, et al.

However, while development continues in addressing the extermination of flying pests in an outdoor environment these efforts have not led to solutions for commercial and non-commercial institutions struggling with the prevention and control of bed bugs.

### SUMMARY OF THE INVENTION

Accordingly, the present invention is directed to an apparatus for controlling and exterminating pests, which includes an electrically powered heat source, a source of a volatile material adjacent to the heat source, the volatile material including a pesticide, and a source of carbon dioxide, wherein emitted heat and carbon dioxide attract the pests and wherein the volatile material is vaporized by the heat, thereby exterminating the attracted pests. Preferably, the pesticide is a pyrethrum, which is most preferably selected from acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, and mixtures thereof. Preferably the volatile material also includes a fragrance. Furthermore, it is also within the scope of the present invention that the pesticide includes an insect growth regulator.

### DETAILED DESCRIPTION OF PREFERRED EMBODIMENTS

The present invention is directed to a plug-in device useful in controlling and preventing infestations of pests such as bed bugs, although other pests also may be controlled to a certain degree. Exemplary of such pests are fleas, head lice, dust mites, mosquitoes, moths, roaches, ants and a variety of other crawling and flying insects. Specifically, the present invention addresses the needs of hotels, cruise ships, shelters, and other institutions, which must regularly provide sleeping quarters for an ever changing population of residents, some of whom may unwittingly bring bed bugs to their temporary room. The present plug-in devices may be used regularly by such institutions as an important part of their efforts to control and prevent infestations.

Preferably, the insecticide emitted by the present plug-in device is of the type which kills the target insect on contact. Therefore, it is more preferred that the insecticide is a pyrethrum. Pyrethrins are natural insecticides produced by certain species of the chrysanthemum plant. The flowers of the plant are harvested shortly after blooming and are either dried and powdered or the oils within the flowers are extracted with solvents. The resulting pyrethrin containing dusts and extracts usually have an active ingredient content of about 30%. These active insecticidal components are collectively known as pyrethrins. Two pyrethrins are most prominent, pyrethrin-I and pyrethrin-II. The pyrethrins have another four different active ingredients, Cinerin I and II and Jasmolin I and II. Pyrethrin compounds have been used primarily to control human lice, mosquitoes, cockroaches, beetles and flies.

The natural pyrethrins are contact poisons which quickly penetrate the nerve system of the insect. A few minutes after application, the insect cannot move or fly away. But, a “knockdown dose” does not mean a killing dose. The natural pyrethrins are swiftly detoxified by enzymes in the insect. Thus, some pests will recover. To delay the enzyme action so a lethal dose is assured, organophosphates, carbamates, or synergists often are added to the pyrethrins.

Semisynthetic derivatives of the chrysanthemumic acids have been developed as insecticides. These are called pyrethroids and tend to be more effective than natural pyrethrins while they are less toxic to mammals. One common synthetic pyrethroid is allethrin.

For purposes of the present patent application, the term “pyrethrins” refers to the natural insecticides derived from chrysanthemum flowers; “pyrethroids” are the synthetic chemicals, and “pyrethrum” is a general name covering both compounds.

In accordance with the present invention the insecticide is preferably a pyrethrum and the pyrethrum is selected from pyrethrins, acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, and mixtures thereof.

It should be noted that although pyrethrums are preferred as the insecticide for use in the present invention which kills the target pests immediately, other known killing pesticides may also be employed in accordance with the present invention.

In addition to an insecticide which kills the target pests immediately, it is preferred that the present plug-in device also emits an insect growth regulator. Rather than killing the target insect, insect growth regulators interrupt or inhibit the life cycle of the pest. The insects are rendered incapable of reproducing because they are not allowed to reach full maturity. In addition to neutering the bed bugs, the correct insect growth regulator can prevent them from biting. Thus, while not directly killing the pests, insect growth regulators are important components of any plan for controlling an insect infestation and are useful for inclusion as a component of the volatile material emitted by the present plug-in device.

Other potential additives include Piperonyl Butoxide and n-Octyl Bicycloheptene Dicarboximide, both of which are pesticide synergists. Neither by itself have pesticidal properties. However, when added to insecticide mixtures, typically pyrethrums or carbamates, the primary insecticide's potency is increased considerably.

In addition to emitting an insecticide, the present plug-in device also emits heat and carbon dioxide. Prior art plug-in devices are known to emit heat as a means of volatizing a volatile material to be emitted, most typically a fragrance. Similarly, in accordance with the present invention a heat source is employed as a means for volatilizing the pesticide to be emitted. However, along with emitted carbon dioxide, the generated heat is also employed as a means for attracting the target pests. Any electrically powered heat source, such as those typically employed in prior art plug-in devices, may be employed in accordance with the present invention.

Unlike prior art plug-in devices, however, the present device further requires a source of carbon dioxide. In combination with the heat source, carbon dioxide is employed to attract the target pests. The combination of heat and carbon dioxide effectively simulates a sleeping host. Any satisfactory carbon dioxide source, such as replaceable carbon dioxide cartridges, may be employed. The carbon dioxide source may be set to emit a low, steady flow of CO₂ or more concentrated amounts may be emitted at desired intervals.

Accordingly, the heat source volatizes the insecticide and any other desirable volatile substances, and, in combination with the carbon dioxide attracts the pests to the source of the insecticide. Preferably, one or more devices are plugged into electrical sockets in the bedroom to be treated and as near to the bed as possible. Interestingly, junction boxes near the sleeping area are known hiding places for bed bugs and a prime area for insecticidal activity.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims. Moreover, Applicant hereby discloses all subranges of all ranges disclosed herein. These subranges are also useful in carrying out the present invention.

What is claimed is:

1. An apparatus for controlling and exterminating pests, the apparatus comprising:
an electrically powered heat source;
a source of a volatile material adjacent to the heat source, the volatile material comprising a pesticide; and
a source of carbon dioxide;
wherein emitted heat and carbon dioxide attract the pests and wherein the volatile material is vaporized by the heat, thereby exterminating the attracted pests.

2. The apparatus set forth in claim 1 wherein the pesticide comprises a pyrethrum.

3. The apparatus set forth in claim 2 wherein the pyrethrum is selected from the group consisting of acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, and mixtures thereof.

4. The apparatus set forth in claim 1 wherein the volatile material further comprises a fragrance.

5. The apparatus set forth in claim 1 wherein the pesticide comprises an insect growth regulator.
